(19) United States
(12) Patent Application Publication
(10) Pub. No.: US 2024/0210935 A1
(43) Pub. Date: Jun. 27, 2024

(54) PREDICTIVE MODEL FOR DETERMINING OVERALL EQUIPMENT EFFECTIVENESS (OEE) IN INDUSTRIAL EQUIPMENT

(71) Applicant: Delaware Capital Formation, Inc., Wilmington, DE (US)

(72) Inventors: Bodhayan Dev, Sturbridge, MA (US); Prem Swaroop, Lexington, MA (US); Richard Buteau, Austin, TX (US); Girish Juneja, Lexington, MA (US); Sreedhar Patnala, Holliston, MA (US)

(21) Appl. No.: 18/087,633

(22) Filed: Dec. 22, 2022

(51) Int. Cl. G05B 23/02

(52) U.S. Cl. CPC G05B 23/0283; G05B 23/0216; G05B 23/024

(57) ABSTRACT

Among other things, systems and techniques are described for a predictive model for determining overall equipment effectiveness (OEE) in industrial equipment. Data including spectral features is obtained. A probability of survival is determined by fitting at least one degradation function to degradation data associated with the industrial equipment. An overall equipment effectiveness metric is predicted as a product of predicted planned production time, predicted performance, and predicted quality output by trained machine learning models.

### FIELD OF THE INVENTION

The present systems and techniques relate to a predictive model for determining overall equipment effectiveness (OEE) in industrial equipment.

### BACKGROUND

Machinery refers to a driven mechanical structure that applies forces and controls movement to execute one or more actions. Generally, a machine converts power input to the machine into a specific application of output forces and movement. Machine elements include, for example, structural components, movement control components, and general control components. Structural components include frame members, bearings, axles, splines, vanes, shafts, fasteners, seals, and lubricants. Movement control components include gear trains, belt or chain drives, linkages, and cam and follower mechanisms. General control components include buttons, switches, indicators, logic, sensors, actuators and computer controllers.

Sensors can be used to capture data associated with industrial equipment. Industrial equipment includes machines used in manufacturing and fabrication. For example, industrial equipment includes but is not limited to pumps, heavy duty industrial tools, compressors, automated assembly equipment, and the like. Industrial equipment also includes machine parts and hardware, such as springs, nuts and bolts, screws, valves, pneumatic hoses, and the like.

### SUMMARY

In general, one or more aspects of the subject matter described in this specification can be embodied in one or more methods, systems, or storage media. A method includes obtaining, with at least one hardware processor, data associated with industrial equipment, wherein the data comprises spectral features corresponding to different frequencies of sensor data for the industrial equipment. The method also includes determining, with the at least one hardware processor, a probability of survival by fitting at least one degradation function to degradation data associated with the industrial equipment, the degradation data based on useful operational periods of time in the spectral plot. Additionally, the method includes predicting, with the at least one hardware processor, an overall equipment effectiveness metric as a product of predicted planned production time, predicted performance, and predicted quality output by trained machine learning models, wherein the predicted performance and the predicted quality are based on the probability of survival, and the overall equipment effectiveness metric identifies productivity of the industrial equipment at future points in time.

A system includes at least one hardware processor and at least one computer-readable medium storing computer-executable instructions. The computer-executable instructions, when executed by the at least one hardware processor, cause the at least one hardware processor to obtain data associated with industrial equipment, wherein the data comprises spectral features corresponding to different frequencies of sensor data for the industrial equipment. The computer-executable instructions cause the at least one hardware processor to determine a probability of survival by fitting at least one degradation function to degradation data associated with the industrial equipment, the degradation data based on useful operational periods of time in the data comprising spectral features. The computer-executable instructions cause the at least one hardware processor to predict an overall equipment effectiveness metric as a product of predicted planned production time, predicted performance, and predicted quality output by trained machine learning models, wherein the predicted performance and predicted quality are based on the probability of survival and the overall equipment effectiveness metric identifies productivity of the industrial equipment at future points in time.

At least one non-transitory storage media stores instructions that, when executed by at least one processor, cause the at least one processor to obtain data associated with industrial equipment, wherein the data comprises spectral features corresponding to different frequencies of sensor data for the industrial equipment. The at least one non-transitory storage media stores instructions that cause the at least one processor to determine a probability of survival by fitting at least one degradation function to degradation data associated with the industrial equipment, the degradation data based on useful operational periods of time in the data. Additionally, the at least one non-transitory storage media stores instructions that cause the at least one processor to predict an overall equipment effectiveness metric as a product of predicted planned production time, predicted performance, and predicted quality output by trained machine learning models, wherein the predicted performance and the predicted quality are based on the probability of survival, and the overall equipment effectiveness metric identifies productivity of the industrial equipment at future points in time.

Some of the advantages of these techniques include a robust predictive OEE metric based on historical data and precise, high resolution (with respect to time) usage data. Further, large amounts of sensor data associated with the industrial equipment are distilled down to an informative visual representation of the data that enables visual recognition of the operating conditions of the industrial equipment. Additionally, visualization of sensor signatures across extended periods on a spectrogram can be deployed on edge devices and presented on a user interface, such as to operators on the factory floor at an operational site.

### BRIEF DESCRIPTION OF THE DRAWINGS

FIG. 1 is a block diagram of an edge architecture operable via a network that includes one or more sensor hubs.

FIG. 2 is a workflow that generates a predictive OEE metric of industrial equipment based on usage and historical data.

FIG. 3 shows a spectral plot corresponding to data captured by a sensor hub.

FIG. 4 shows views of a survival plot.

FIG. 5 shows historical production of industrial equipment.

FIG. 6 is a process flow diagram of a method for predicting an overall equipment effectiveness metric.

FIG. 7 is a block diagram of a system that enables predictive model for determining a predictive OEE metric for industrial equipment.

The patent or application file contains at least one drawing executed in color. Copies of this patent or patent application publication with color drawing(s) will be provided by the Office upon request and payment of the necessary fee.

### DETAILED DESCRIPTION

In the following description, for the purposes of explanation, numerous specific details are set forth in order to provide a thorough understanding of the present invention. It will be apparent, however, that the present invention can be practiced without these specific details.

In other instances, well-known structures and devices are shown in block diagram form in order to avoid unnecessarily obscuring the present invention.

Reference will now be made in detail to embodiments, examples of which are illustrated in the accompanying drawings. In the following detailed description, numerous specific details are set forth in order to provide a thorough understanding of the various described embodiments. However, it will be apparent to one of ordinary skill in the art that the various described embodiments may be practiced without these specific details. In other instances, well-known methods, procedures, components, circuits, and networks have not been described in detail so as not to unnecessarily obscure aspects of the embodiments.

Artificial intelligence (AI) includes, for example, machine learning (ML). ML models (hereinafter “models”) and corresponding industrial equipment are implemented across a variety of industries that produce end products. The models are trained to make predictions (e.g., forecast what will happen) based on input data, which includes data associated with industrial equipment, sensor data, data captured by a sensor hub, vibration data, and the like. Trained models are deployed in industry and evaluate input data to make predictions. In examples, the trained models output predictive information associated with the industrial equipment, such as planned production time, performance, and quality.

Embodiments described herein enable a predictive model for determining an overall equipment effectiveness (OEE) of industrial equipment. A framework is enabled that uses sensor hubs and corresponding industrial equipment to collect sensor data and determine a predictive OEE metric of the equipment. In examples, the industrial equipment is located on factory floors of an operational site. The predictive OEE metric is determined based on usage and historical data. Spectral data is obtained from the sensor data. Useful operational periods of time and degradation profiles are used to determine a probability of survival. In examples, a threshold that marks the useful operational periods of time is determined based on the spectral data. Machine learning models are trained to predict planned production time, performance, and quality. In examples, a first machine learning model is trained to predict planned production time based on historical production data; a second machine learning model is trained to predict performance of the industrial equipment based on the probability of survival and historical performance data; and a third machine learning model is trained to predict quality of the industrial equipment based on the probability of survival and historical quality data. The predictive OEE metric is computed as the product of the predicted planned production time, predicted performance, and predicted quality.

The predictive OEE metric describes the OEE as a function of time, and the time-based visual representation enables a high-resolution view of pause/non operation periods of the industrial equipment. The useful run-time of industrial equipment is efficiently determined according to vibrations or sensor signatures corresponding to the sensor data, instead of basing the run-time on an on/off mechanism of a programmable logic controller (PLC) that controls the industrial equipment. Visualization of the vibrations or sensor signatures on a spectral plot, such as a spectrogram, can span an extended time period. The predictive OEE metric can be determined using ML models deployed on edge devices, and the predictive OEE metric and spectral plot can be presented on a user interface in real-time.

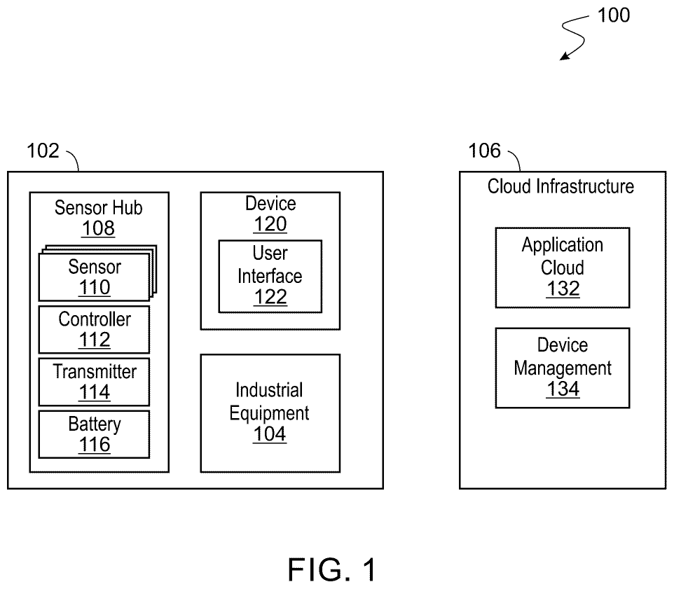

FIG. 1 is a block diagram of an edge architecture operable via a network 100 that includes one or more sensor hubs. In some embodiments, the network 100 is a low power, peer-to-peer, multi-hop wireless network. An operational site 102 is communicatively coupled with a cloud infrastructure 106. In some embodiments, the operational site 102 is a location where industrial equipment 104 operates. One or more operators are located at the operational site, and the operators manage the equipment. In some embodiments, the cloud infrastructure 106 is a computing platform operated by a third party for application management via around the world—distributed data centers, such as a Microsoft Azure cloud. In examples, the cloud infrastructure 106 provides a broad range of cloud services, including compute, analytics, storage and networking. Users can pick and choose from these services to develop and scale applications, and existing applications can execute from the cloud infrastructure 106. In examples, the network 100 establishes a communication protocol between the operational site 102 and the cloud infrastructure 106.

The operational site also includes at least one sensor hub 108. The sensor hub 108 captures sensor data associated with industrial equipment 104 and transmits the sensor data using the network 100. The industrial equipment 104 includes, for example, pumps, heavy duty industrial tools, compressors, automated assembly equipment, and the like. The industrial equipment can further include machines such as turning machines (e.g., lathes and boring mills), shapers and planers, drilling machines, milling machines, grinding machines, power saws, cutting machines, stamping machines, and presses.

In examples, the sensor data captured by the sensor hub 108 is transmitted to a device 120 via a series of nodes and routers. A sensor hub 108 according to the present systems and techniques captures data associated with industrial equipment 104 and transmits the data as needed. As shown, the sensor hub 108 includes one or more sensors 110. In examples, the one or more sensors 110 is an accelerometer, three-axis accelerometer, inertial measurement unit (IMU), a temperature sensor, gyroscope, magnetometer, or any combinations thereof. Other suitable sensors may be, for example pressure sensors, humidity sensors, current sensors, voltage sensors, particle count sensors, flow-rate sensors, level measurement sensors, speed sensors, distance sensors, proximity detection sensors, up-down count sensors, etc. In some embodiments, multiple sensor hubs are mounted (e.g., physically coupled) in various locations on the industrial equipment 104 to measure and record sensor data (e.g., vibrations) in real time.

The sensor hub 108 includes a controller 112. The controller 112 includes one or more processing cores and memory. In examples, the controller 112 is a system on a chip (SoC). Additionally, in examples the controller 112 is a mixed signal controller that integrates both analog and digital inputs as captured by one or more sensors 110. The sensor hub 108 also includes a transmitter 114. The transmitter enables the transmission of sensor data captured by the one or more sensors 110 on the network 100. As shown in the example of FIG. 1, the sensor hub includes a battery 116. In examples, the battery 116 is rechargeable or replaceable. In some embodiments, the battery 116 supplies power to sensor 110, controller 112, and transmitter 114.

In some embodiments, the sensor data (e.g., output of one or more sensors 110) is used to train one or more machine learning models. In some embodiments, the sensor data is input to a trained machine learning model to characterize the operation of the industrial equipment. In examples, one or more sensor-hubs ingest raw sensor data captured by multiple sensors (e.g., sensors 110). In some embodiments, sensor data includes multiple rotating component speeds, system electric current consumed by operating parts, machine vibration and orientation, operating temperature, and any other suitable characteristics that the industrial equipment can exhibit.

In some embodiments, trained machine learning models are deployed at a device 120 located at the operational site 102. The device 120 includes a user interface 122. The sensor data is captured by one or more sensors of a sensor hub 108 and sensor data is transmitted via transmitter 114 to device 120. In examples, the device 120 executes condition monitoring applications for predictive maintenance of the industrial equipment, and the output of these applications is rendered via the user interface 122. In examples, the device 120 is a tablet computer, cellular phone, laptop, or other mobile electronic device. In some embodiments, the device 120 operates using an Android or iOS based operating system. The device 120 is communicatively coupled with the cloud infrastructure 106. In some embodiments, the device 120 communicates with the cloud infrastructure 106 using a Long-Term Evolution (LTE) or Wi-Fi communication standard. The cloud infrastructure 106 includes an application cloud 132 and device management 134. In some embodiments, an application cloud 132 is used to render data in a central web dashboard so that an operator can observe trends associated with the industrial equipment over time to understand degradation of the equipment. In some embodiments, device management 134 includes a web application used to manage lifecycle of the IoT devices, such as the sensor hubs 108, deployed at operational sites. Device management includes, for example, deploying a new device, over-the-air software updates, rebooting an unresponsive device remotely, etc. In some embodiments, the sensor data is processed locally at the device 120 before transmitting it to the cloud infrastructure 106. For example, the device 120 can aggregate or de-duplicate the sensor data as a way of reducing the volume of data that is transmitted to the cloud infrastructure 106.

Sensor-hubs are installed at operational sites to capture sensor data. The data acquisition parameteres can be customized based on the equipment type. Multiple sensor types, such as temperature sensor(s), current sensor(s), infrared sensor(s) and accelerometer(s) can be connected to the sensor-hubs. In examples, sensor data can be presented via a user interface 122 for operators such as factory technicians. Sensor data, collected over an extended period could result in storage issues. An extended period of time is, for example, on the order of multiple weeks of captured sensor data. Visualizing weeks of sensor data over multiple weeks is often infeasible due to limited storage and processing capabilities of devices used at operational sites, such as device 120. In some embodiments, the sensor data, including raw-sensor/vibration data, are converted to Power-Spectral Density (PSD)/Fast-Fourier Transforms (FFT) or similar spectral features. The spectral features are represented using a spectral plot, which the operators at the operational site 102 can access/visualize at their convenience. Using the spectral data and degradation profiles, a predictive OEE metric is generated.

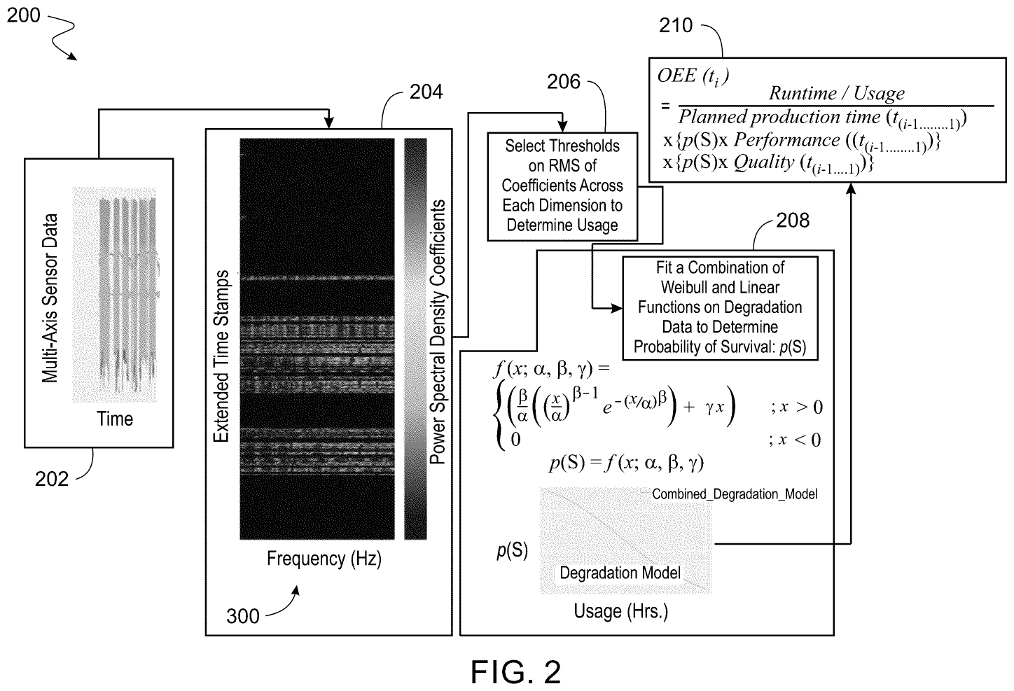

FIG. 2 is a workflow 200 that generates a predictive OEE metric of industrial equipment based on usage and historical data. As shown in the example of FIG. 2, the workflow 200 focuses on utilizing ML based techniques to predict survival probability of wearable components of the industrial equipment. In examples, wearable components are components that are subject to failure from one or more wear mechanisms. In examples, root causes of wear on components of industrial equipment are abrasion, corrosion, fatigue, boundary lubrication, deposition, erosion, cavitation, and electrical discharge. The survival probability is used to determine a planned production time, performance, and quality of the output of the industrial equipment. In some embodiments, the planned production time, performance, and quality are inputs to a predictive OEE metric that can be tracked by operators to schedule planned maintenance or other related tasks. The workflow 200 is cloud and hardware agnostic and can be deployed in any suitable environment. In some embodiments, the workflow 200 executes at the cloud (e.g., cloud 106). In addition, the workflow 200 can enable periodic model retraining at the discretion of operators. The workflow also enables signature visualizations of the sensor data over extended time periods.

At block 202, multi-axis sensor data is captured. The multi axis sensor data can be vibration data captured by a three-axis accelerometer (e.g., sensor 110 of FIG. 1). In examples, the three-axis accelerometer is a component of a sensor hub (e.g., sensor hub 108 of FIG. 1). Although multi axis sensor data, such as vibration data, is described as the data captured in the workflow 200, any suitable sensor data can be used according to the present techniques.

At block 204, the captured data is transformed to a spectral plot 300. Features are extracted from the captured sensor data to derive the spectral plot. The features may include a signature that corresponds to a characterization of the underlying sensor data. In examples, the spectral plot presents the vibration or sensor signatures over extended periods in an efficient manner via a user interface that is conducive to edge deployment where storage of massive sensor data can be challenging.

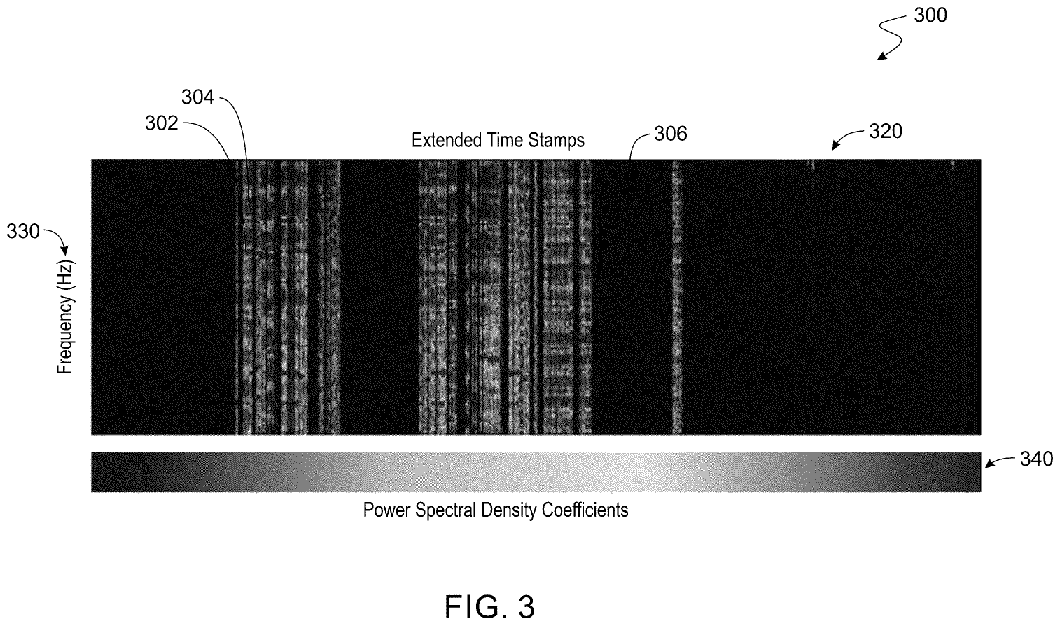

FIG. 3 shows a spectral plot 300 corresponding to data comprising spectral features captured by a sensor hub. A spectral plot 300 characterizes the frequency content of the signal according to the spectral density of the sensor data. In the example of FIG. 3, power spectral density coefficients represent the spectral energy distribution in the frequency components of the captured sensor data per unit time. A statistical average of the captured sensor data is analyzed in terms of its frequency content, referred to as its spectrum. As shown in FIG. 3, the power spectral density coefficients are a function of frequency along the y-axis 330. Time is represented along the x-axis 320. The spectral density of a window of a longer signal (e.g., sensor data captured over an extended period of time) is calculated and plotted versus time associated with the window. Such a graph is called a spectrogram. In some embodiments, the spectrogram presented to a user, and the spectrogram includes a visual representation of the data corresponding to operation periods of the industrial equipment.

Signatures in the spectral plot are determined by one or more patterns present in the spectral plot. For example, in FIG. 3, red areas 302 on the spectral plot represent higher power spectral density coefficients, while blue areas 304 represent lower power spectral density coefficients. The colors of spectral plot 300 represent power spectral density coefficients, from highest to lowest, by red, orange, yellow, green, and blue as shown by the power spectral coefficient legend 340. In some portions of the spectral plot 300, the areas 302 and 304 alternate in a pattern 306. The pattern 306 forms a signature in the spectral plot 300. In examples, the signature can characterize operating conditions of the industrial equipment. The signatures formed by the spectral plot are monitored, and the signatures are compared to known signatures in real time. In some embodiments, one or more deviations between signatures in the spectral plot and the known signatures is observed and an alert is provided to a user in response to a detected deviation. As used herein, an operating condition is a phenomenon that is observed during some form of work or production (e.g., operation) by the industrial equipment. An operating condition can include one or more levels or stages that indicate an increasing severity of the operating condition.

Referring again to FIG. 2, at block 206 usage is determined. In examples, usage is a measure of productivity of the industrial equipment. Poor usage can result in increased labor and overhead costs. The present techniques enable a precise quantification of usage based on the spectral data derived at block 204. In examples, based on PSD features, a root-mean squared (RMS) value of spectral features across each dimension of captured sensor data is computed. A threshold is selected to determine the useful operational time of the equipment. In some embodiments, the threshold is a median of a root mean square (RMS) of spectral features of the spectrogram.

Referring again to FIG. 3, the blue areas 304 typically represent the periods where the industrial equipment is paused or otherwise inoperaable. The spectral plot 300 of FIG. 3 also provides power spectral density coeeficients that vary according to the power spectral coefficient legend 340, corresponding to points in time where the industrial equipment is operable at varying workloads. Accordingly, the present techniques enable a continuous representation of usage associated with industrial equipment. This precise representation of usage goes beyond on/off operation monitoring using PLCs. In some embodiments, the present techniques are used with industrial equipment that lack PLCs.

Referring again to FIG. 2, at block 208, a probability of survival is determined. In examples, the useful operational periods are determined according to the usage of the industrial equipment. The useful life of the industrial equipment is evaluated based on an installation date and a failure date. For example, degradation data is calculated using a period of time starting from an installation or maintenance point of the industrial equipment to a failure point of the industrial equipment. Degradation data represents a decline in useful or healthy life of industrial equipment due to usage. Once the degradation data is available (e.g., after a failure of the industrial equipment), one or more degradation functions are used to determine a probability of survival. As usage is tracked from installation to failure of the industrial equipment, different forms of degradation functions can be fit onto the usage data to create a degradation profile that indicates the healthy life/remaining useful life of the equipment. In examples, curve fitting is used to model the degradation data spread by assigning a predetermined, best fit function along the range covered by the degradation data. In examples, the predetermined function is a linear, exponential, power, logarithmic, Gompertz, or Lloyd-Lipow degradation function, or any combinations thereof. For example, the predetermined function is an ensemble model that is a combination of Weibull and linear functions that characterize success/failure data, such as degradation data, over time.

The probability of survival, p(S)=f(x;α,β,γ) is as follows:

$$f ( x ; α , β , γ ) = \{ \begin{matrix}( \frac{β}{α} ( {( \frac{x}{α} )}^{β - 1} {e}^{- {( x / α )}^{β}} + γ x ) ; x > 0 \\ 0 ; x < 0\end{matrix}$$

Where α, β, γ are model parameters learnt during the fitting process. Degradation modeling enables effective reliability analysis of failures of the industrial equipment caused by degradation.

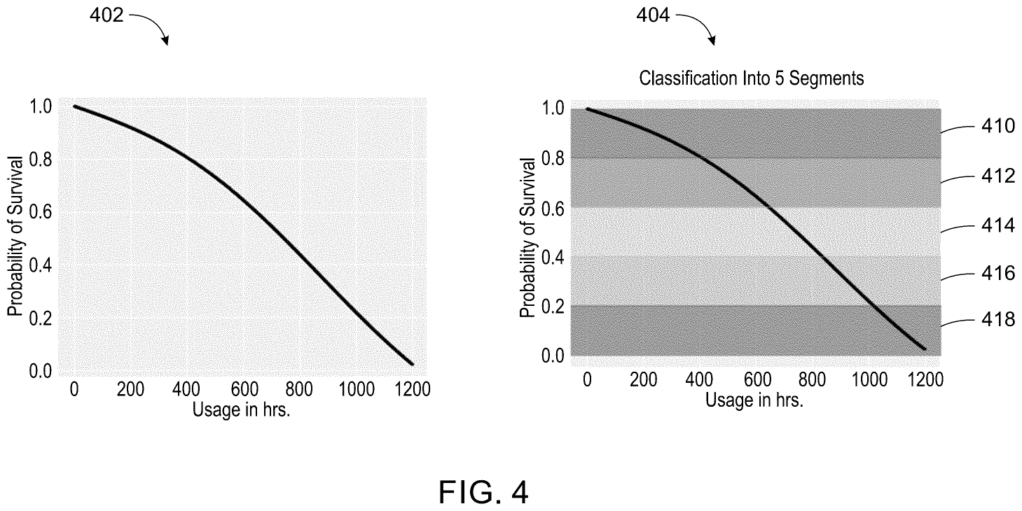

FIG. 4 shows views of a survival plot. In examples, the survival plot is a graph of the probability of survival over time. The probability of survival is used to predict a remaining useful life (RUL) of the industrial equipment. The probability of survival is a value ranging from 0 to 1 as shown on the y-axes of a first view 402 and a second view 404 of the survival plot in FIG. 4. The x-axes of the first view 402 and the second view 404 represent time. In examples, if an industrial equipment is rated to be safely operating with probability of survival of at least 80%, the RUL would be equal to a usage value in hrs./days/months corresponding to a probability score of 0.8. In some embodiments, the RUL of the industrial equipment is based on a current health status of the industrial equipment and a minimum acceptable health status of the industrial equipment. In the example of FIG. 4, the first view 402 shows the probability of survival of an industrial equipment and a decline in the probability of survival as usage increases. The second view 404 shows the probability of survival with a decline in the probability of survival as usage increases, where the probability of survival is segmented into at least two operational states. In some embodiments, a survival plot is presented to a user with segments that indicate at least two operational states of the industrial equipment over time. As shown in the second view 404, the survival plot is divided into segments 410, 412, 414, 416, and 418 that classify the probability of survival. Segments 410 and 412 represent a healthy/good state of the industrial equipment, segments 414 and 416 represent a declining state change of the industrial equipment, and segment 418 represents a close to failure/approaching failure state of the industrial equipment. In examples, the states of the industrial equipment are provided (e.g., broadcast) at the operational site. At a factory floor where the industrial equipment operates, various colors corresponding to the remaining useful life are shown on the factory floor. For example, green colors (e.g., segments 410 and 412) represent a healthy/good state of the industrial equipment, a yellow-orange colors (e.g., segments 414 and 416) represent a declining state change of the industrial equipment, and red (e.g., segment 418) represents a close to failure/approaching failure state of the industrial equipment. The colors are rendered on a display screen or using a stack light with varying colors corresponding to the operational state of the industrial equipment. Although only five segments are described, the survival plot can be segmented into any suitable number of segments.

Referring again to FIG. 2, at block 210, an OEE metric is determined based on the probability of survival. Overall equipment effectiveness (OEE) is defined as follows:

$$OEE = Availability \times Performance \times Quality$$

$$Availability = \frac{Runtime / Usage}{Planned production time}$$

A ML based predictive model predicts the planned production time based on historical data. Planned production time is the time or duration for which the manufacturing process is intended to operate (e.g., engaged in production). In examples, planned production time is determined by analyzing historical industrial equipment availability and operator availability. The trained ML model obtains as input historical data for the planned production time until time=t(i−1) and outputs a predicted planned production time. Using the historical planned production time data, the ML model learns features/trends to predict the planned production for future timestamps at time=t, t+1, t+2, . . . , t+i, where i>0. Using the output of a ML model trained to predict planned production time, an availability of the industrial equipment is calculated as follows:

$$Availability ( {t}_{( i )} ) = \frac{Runtime / Usage}{Planned production time ( {t}_{( i - 1 … … 1 )} )}$$

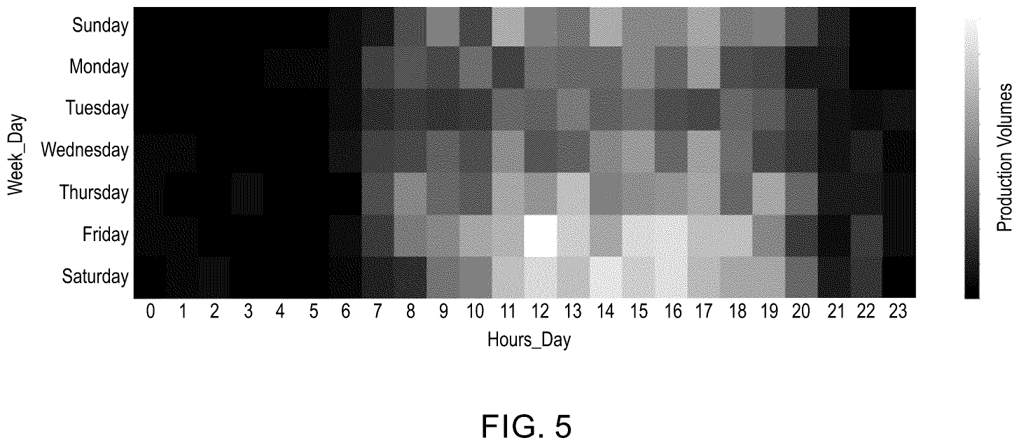

In examples, the availability is the amount of time in which the industrial equipment is operational and is available for production. FIG. 5 shows historical production of industrial equipment. In the example of FIG. 5, predicted availability (based on the ML-based planned production time) is used to visualize the historical production volumes. In some embodiments, the historical production volumes are rendered on a user interface (e.g., user interface 122 of FIG. 1) of a device (e.g., device 120 of FIG. 1) deployed at an operational site (operational site 102 of FIG. 1). As shown in FIG. 5, production volume is presented as a function of a day of the week and hour of day, with lighter colors representing increased production volumes of the industrial equipment. The visualization of historical production volumes enables tracking of production shifts.

Referring again to FIG. 2, at block 210 ML-based predictive models are used to predict predict performance and quality, respectively, based on historical data. In examples, quality is defined as a portion of saleable units out of all units produced by the industrial equipment. In examples, performance is the speed at which the industrial equipment runs compared to its fastest-possible or ideal speed. In some embodiments, performance and quality parameters are adjusted to account for the degradation of wearable components of the industrial equipment by including using the probability of survival p(S)as a multiplicative factor of the respective parameter. For example, performance is calculated as the probability of survival p(S) multiplied by the ML-based performance as follows:

$${Performane}_{Adjusted} = \{ p ( S ) \times Performance ( {t}_{i - 1 , … , … 1 )} ) \}$$

A trained ML model obtains as input historical performance data until time=t(i−1), and outputs the performance associated with the industrial equipment. In examples, the historical performance data includes equipment RPM/line speed during operations. Using the historical performance data, the ML model learns features/trends to predict performance for future timestamps at time=t, t+1, t+2, . . . , t+i, where i>0.

Similarly, quality is calculated is calculated as the probability of survival p(S) multiplied by the ML-based quality as follows:

$${Quality}_{Adjusted} = \{ p ( S ) \times Quality ( {t}_{i - 1 … … 1 )} ) \}$$

A trained ML model obtains as input historical quality data, and outputs the quality associated with the industrial equipment. In examples, the historical quality data quantifies the portion of saleable units out of all units produced by the industrial equipment, excluding manufactured parts that do not meet quality standards including parts that need rework. Using the historical quality data, the ML model learns features/trends to predict performance for future timestamps at time=t, t+1, t+2, . . . , t+i, where i>0.

Thus, the overall predictive OEE metric is as follows:

$$OEE ( {t}_{i} ) = \frac{Runtime / Usage}{Planned production time ( {t}_{( i - 1 … … 1 )} )} \times \{ p ( S ) \times Performance ( ( {t}_{( i - 1 … … 1 )} ) \} \times \{ p ( S ) \times Quality ( {t}_{( i - 1 … 1 )} ) \}$$

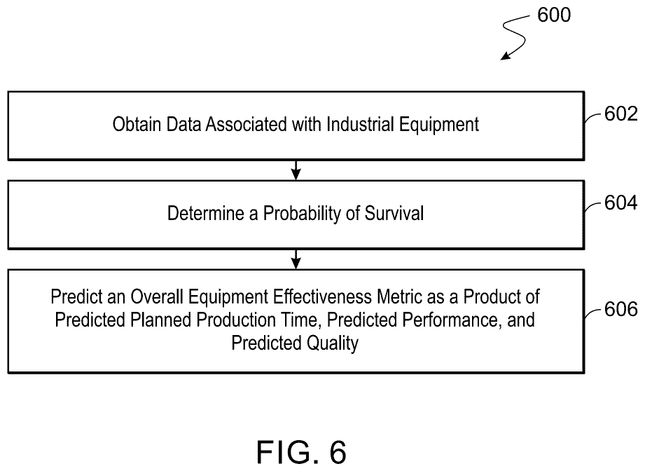

FIG. 6 is a process flow diagram of a method 600 for predicting an overall equipment effectiveness metric.

At block 602, data associated with industrial equipment is obtained. In examples, the data is a spectral data based on sensor data captured by one or more sensor hubs associated with the industrial equipment.

At block 604, a probability of survival is determined by fitting at least one degradation function to degradation data associated with the industrial equipment, the degradation data based on useful operational periods of time in the spectral data. In examples, the at least one degradation function is a Weibull degradation function, a linear degradation function, or combination of the Weibull degradation function and the linear degradation function.

At block 606, an overall equipment effectiveness metric is predicted as a product of predicted planned production time, predicted performance, and predicted quality output by trained machine learning models, wherein the predicted performance and predicted quality are based on the probability of survival and the overall equipment effectiveness metric identifies productivity of the industrial equipment at future points in time. In examples, preventative maintenance is executed based on the predictive OEE metric. Preventive maintenance includes, for example, performing actions to detect, preclude, or mitigate degradation of a component or system of the industrial equipment to sustaining or extending its useful life (above a threshold) by controlling degradation to an acceptable level.

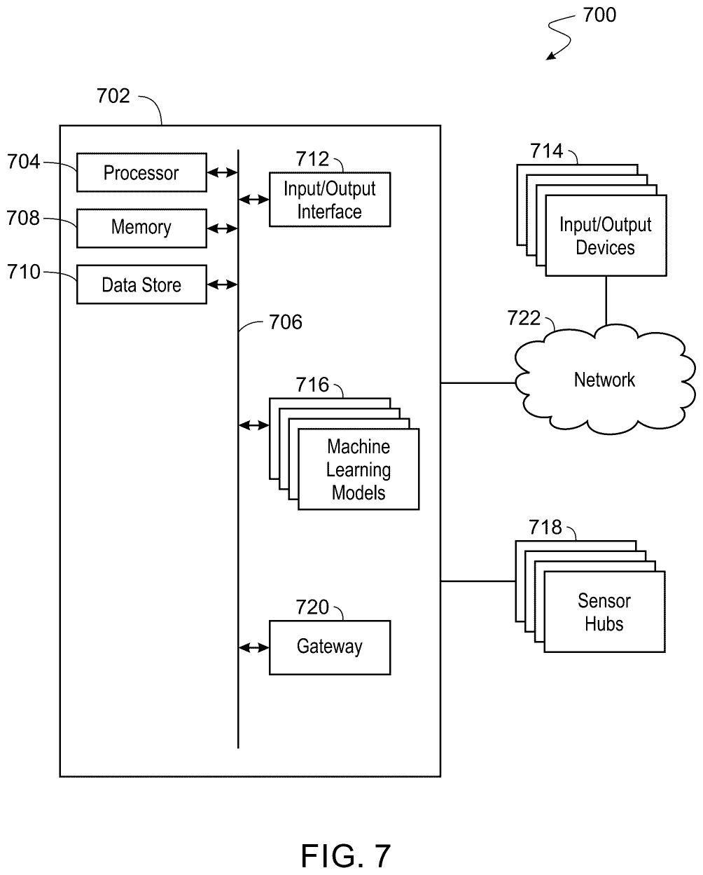

FIG. 7 is a block diagram of a system 700 that enables predictive model for determining a predictive OEE for industrial equipment. The system 700 can execute the process 600 of FIG. 6. In examples, the system 700 includes, among other equipment, a controller 702. In some embodiments, the controller 702 consumes very little energy and is efficient. In examples, the controller 702 is a component of (or is) a mobile device, such as a cellular phone, tablet computer, and the like. In some cases, the controller 702 is operable using battery power and is not required to be connected to mains power.

The controller 702 includes a processor 704. The processor 704 can be a microprocessor, a multi-core processor, a multithreaded processor, an ultra-low-voltage processor, an embedded processor, or a virtual processor. In some embodiments, the processor 704 can be part of a system-on-a-chip (SoC) in which the processor 704 and the other components of the controller 702 are formed into a single integrated electronics package.

The processor 704 can communicate with other components of the controller 702 over a bus 706. The bus 706 can include various technologies, such as industry standard architecture (ISA), extended ISA (EISA), peripheral component interconnect (PCI), peripheral component interconnect extended (PCIx), PCI express (PCIe), or any number of other suitable technologies. The bus 706 can be a proprietary bus, for example, used in an SoC based system. Other bus technologies can be used, in addition to, or instead of, the technologies above.

The bus 706 can couple the processor 704 to a memory 708. In some embodiments, such as in PLCs and other process control units, the memory 708 is integrated with a data storage 710 used for long-term storage of programs and data. The memory 708 can include any number of volatile and nonvolatile memory devices, such as volatile random-access memory (RAM), static random-access memory (SRAM), flash memory, and the like. In smaller devices, such as programmable logic controllers, the memory 708 can include registers associated with the processor itself. The storage 710 is used for the persistent storage of information, such as data, applications, operating systems, and so forth. The storage 710 can be a nonvolatile RAM, a solid-state disk drive, or a flash drive, among others. In some embodiments, the storage 710 will include a hard disk drive, such as a micro hard disk drive, a regular hard disk drive, or an array of hard disk drives, for example, associated with a distributed computing system or a cloud server.

The bus 706 couples the processor 704 to an input/output interface 712. The input/output interface 712 connects the controller 702 to the input/output devices 714. In some embodiments, the input/output devices 714 include printers, displays, touch screen displays, keyboards, mice, pointing devices, and the like. In some examples, one or more of the I/O devices 714 can be integrated with the controller 702 into a computer, such as a mobile computing device, e.g., a smartphone or tablet computer.

The controller 702 also includes machine learning models 716. The machine learning models 716 are trained using sensor data captured by one or more sensor hubs 718. Sensor data from the sensor hubs 718 is transmitted to the machine learning models 716 using a gateway 720. The gateway 720 enables the controller 702 to transmit and receive information across a network 722. Although not shown in the interests of simplicity, several similar controllers 702 can be connected to the network 722.

A number of embodiments of the invention have been described. Nevertheless, it will be understood that various modifications may be made without departing from the spirit and scope of the invention. Although exemplary processing systems have been described, implementations of the subject matter and the functional operations described above can be implemented in other types of digital electronic circuitry, or in computer software, firmware, or hardware, including the structures disclosed in this specification and their structural equivalents, or in combinations of one or more of them. Implementations of the subject matter described in this specification, such as control of a data generation, model training, and model execution can be implemented as one or more computer program products, i.e., one or more modules of computer program instructions encoded on a tangible program carrier, for example a computer-readable medium, for execution by, or to control the operation of, a processing system. The computer readable medium can be a machine readable storage device, a machine readable storage substrate, a memory device, or a combination of one or more of them.

The term “system” may encompass all apparatus, devices, and machines for processing data, including by way of example a programmable processor, a computer, or multiple processors or computers. A processing system can include, in addition to hardware, code that creates an execution environment for the computer program in question, e.g., code that constitutes processor firmware, a protocol stack, a database management system, an operating system, or a combination of one or more of them.

A computer program (also known as a program, software, software application, script, executable logic, or code) can be written in any form of programming language, including compiled or interpreted languages, or declarative or procedural languages, and it can be deployed in any form, including as a standalone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

Computer readable media suitable for storing computer program instructions and data include all forms of non-volatile or volatile memory, media and memory devices, including by way of example semiconductor memory devices, e.g., EPROM, EEPROM, and flash memory devices; magnetic disks, e.g., internal hard disks or removable disks or magnetic tapes; magneto optical disks; and CD-ROM, DVD-ROM, and Blu-Ray disks. The processor and the memory can be supplemented by, or incorporated in, special purpose logic circuitry. Sometimes a server is a general purpose computer, and sometimes it is a custom-tailored special purpose electronic device, and sometimes it is a combination of these things. Implementations can include a back end component, e.g., a data server, or a middleware component, e.g., an application server, or a front end component, e.g., a client computer having a graphical user interface or a Web browser through which a user can interact with an implementation of the subject matter described is this specification, or any combination of one or more such back end, middleware, or front end components. The components of the system can be interconnected by any form or medium of digital data communication, e.g., a communication network. Examples of communication networks include a local area network (“LAN”) and a wide area network (“WAN”), e.g., the Internet.

In the drawings, specific arrangements or orderings of schematic elements, such as those representing devices, modules, instruction blocks and data elements, are shown for ease of description. However, it should be understood by those skilled in the art that the specific ordering or arrangement of the schematic elements in the drawings is not meant to imply that a particular order or sequence of processing, or separation of processes, is required. Further, the inclusion of a schematic element in a drawing is not meant to imply that such element is required in all embodiments or that the features represented by such element may not be included in or combined with other elements in some embodiments.

Further, in the drawings, where connecting elements, such as solid or dashed lines or arrows, are used to illustrate a connection, relationship, or association between or among two or more other schematic elements, the absence of any such connecting elements is not meant to imply that no connection, relationship, or association can exist. In other words, some connections, relationships, or associations between elements are not shown in the drawings so as not to obscure the disclosure. In addition, for ease of illustration, a single connecting element is used to represent one or more connections, relationships or associations between elements. For example, where a connecting element represents a communication of signals, data, or instructions, it should be understood by those skilled in the art that such element represents one or multiple signal paths (e.g., a bus), as may be needed, to affect the communication.

As used herein, “sensor(s)” includes one or more hardware components that detect information about the environment surrounding the sensor. Some of the hardware components can include sensing components (e.g., vibration sensors, accelerometers), transmitting and/or receiving components (e.g., laser or radio frequency wave transmitters and receivers, transceivers, and the like), electronic components such as analog-to-digital converters, a data storage device (such as a RAM and/or a nonvolatile storage), software or firmware components and data processing components such as an ASIC (application-specific integrated circuit), a microprocessor and/or a microcontroller.

The terminology used in the description of the various described embodiments herein is for the purpose of describing particular embodiments only and is not intended to be limiting. As used in the description of the various described embodiments and the appended claims, the singular forms “a,” “an” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “includes,” “including,” “comprises,” and/or “comprising,” when used in this description, specify the presence of stated features, integers, steps, operations, elements, and/or components, but do not preclude the presence or addition of one or more other features, integers, steps, operations, elements, components, and/or groups thereof.

As used herein, the term “if” is, optionally, construed to mean “when” or “upon” or “in response to determining” or “in response to detecting,” depending on the context. Similarly, the phrase “if it is determined” or “if [a stated condition or event] is detected” is, optionally, construed to mean “upon determining” or “in response to determining” or “upon detecting [the stated condition or event]” or “in response to detecting [the stated condition or event],” depending on the context.

In the foregoing description, embodiments of the invention have been described with reference to numerous specific details that may vary from implementation to implementation. The description and drawings are, accordingly, to be regarded in an illustrative rather than a restrictive sense. The sole and exclusive indicator of the scope of the invention, and what is intended by the applicants to be the scope of the invention, is the literal and equivalent scope of the set of claims that issue from this application, in the specific form in which such claims issue, including any subsequent correction. Any definitions expressly set forth herein for terms contained in such claims shall govern the meaning of such terms as used in the claims. In addition, when we use the term “further comprising,” in the foregoing description or following claims, what follows this phrase can be an additional step or entity, or a sub-step/sub-entity of a previously-recited step or entity.

What is claimed is:

1. A method, comprising:
obtaining, with at least one hardware processor, data associated with industrial equipment, wherein the data comprises spectral features corresponding to different frequencies of sensor data for the industrial equipment;
determining, with the at least one hardware processor, a probability of survival by fitting at least one degradation function to degradation data associated with the industrial equipment, the degradation data based on useful operational periods of time in the data comprising spectral features; and
predicting, with the at least one hardware processor, an overall equipment effectiveness metric as a product of predicted planned production time, predicted performance, and predicted quality output by trained machine learning models, wherein the predicted performance and the predicted quality are based on the probability of survival, and the overall equipment effectiveness metric identifies productivity of the industrial equipment at future points in time.

2. The method of claim 1, wherein the at least one degradation function is a Weibull degradation function, a linear degradation function, or combination of the Weibull degradation function and the linear degradation function.

3. The method of claim 1, wherein the data presented to the user as a spectrogram, the spectrogram comprising a visual representation of the data corresponding to operation periods of the industrial equipment.

4. The method of claim 3, comprising determining the useful operation periods of time according to a threshold, wherein the threshold is a median of a root mean square (RMS) of spectral features of the spectrogram.

5. The method of claim 1, comprising determining a remaining useful life of the industrial equipment based on a current health status of the industrial equipment and a minimum acceptable health status of the industrial equipment.

6. The method of claim 5, comprising presenting a survival plot to a user, the survival plot indicating at least one operational state of the industrial equipment over time.

7. The method of claim 6, wherein the presenting comprises visualizing the remaining useful life in real time by defining segments of the survival plot that correspond to predetermined operational states of the industrial equipment.

8. The method of claim 1, comprising monitoring signatures in the data and comparing the signatures to known signatures in real time.

9. The method of claim 8, comprising:
detecting one or more deviations between signatures in the data and the known signatures; and
providing an alert to a user in response to a detected deviation.

10. A system, comprising:
at least one hardware processor; and
at least one computer-readable medium storing computer-executable instructions;
wherein the computer-executable instructions, when executed by the at least one hardware processor, cause the at least one hardware processor to:
obtain data associated with industrial equipment, wherein the data comprises spectral features corresponding to different frequencies of sensor data for the industrial equipment;
determine a probability of survival by fitting at least one degradation function to degradation data associated with the industrial equipment, the degradation data based on useful operational periods of time in the data comprising spectral features; and
predict an overall equipment effectiveness metric as a product of predicted planned production time, predicted performance, and predicted quality output by trained machine learning models, wherein the predicted performance and predicted quality are based on the probability of survival and the overall equipment effectiveness metric identifies productivity of the industrial equipment at future points in time.

11. The system of claim 10, wherein a first machine learning model of the trained machine learning models is trained to predict planned production time based on historical production data.

12. The system of claim 11, wherein a second machine learning model of the trained machine learning models is trained to predict performance of the industrial equipment based on the probability of survival and historical performance data.

13. The system of claim 12, wherein a third machine learning model of the trained machine learning models is trained to predict quality of the industrial equipment based on the probability of survival and historical quality data.

14. The system of claim 10, comprising a mobile device with a display, wherein the instructions cause the at least one hardware processor to render a spectral plot representing the data comprising spectral features at the display.

15. The system of claim 10, comprising at least one sensor that captures sensor data associated with the industrial equipment, and the instructions cause the at least one hardware processor to convert the sensor data to the data comprising spectral features.

16. At least one non-transitory storage media storing instructions that, when executed by at least one processor, cause the at least one processor to:
obtain data associated with industrial equipment, wherein the data comprises spectral features corresponding to different frequencies of sensor data for the industrial equipment;
determine a probability of survival by fitting at least one degradation function to degradation data associated with the industrial equipment, the degradation data based on useful operational periods of time in the data comprising spectral features; and
predict an overall equipment effectiveness metric as a product of predicted planned production time, predicted performance, and predicted quality output by trained machine learning models, wherein the predicted performance and the predicted quality are based on the probability of survival, and the overall equipment effectiveness metric identifies productivity of the industrial equipment at future points in time.

17. The at least one non-transitory storage media of claim 16, wherein the at least one degradation function is a Weibull degradation function, a linear degradation function, or combination of the Weibull degradation function and the linear degradation function.

18. The at least one non-transitory storage media of claim 16, wherein the data comprising spectral features is presented to the user as a spectrogram, the spectrogram comprising a visual representation of the data corresponding to operation periods of the industrial equipment.

19. The at least one non-transitory storage media of claim 18, comprising determining the useful operation periods of time according to a threshold, wherein the threshold is a median of a root mean square (RMS) of spectral features of the spectrogram.

20. The at least one non-transitory storage media of claim 19, comprising determining a remaining useful life of the industrial equipment based on a current health status of the industrial equipment and a minimum acceptable health status of the industrial equipment.
